(19) United States
(12) Patent Application Publication
(10) Pub. No.: US 2016/0067793 A1
(43) Pub. Date: Mar. 10, 2016

(54) JIGS AND METHODS FOR CONSISTENT MANUAL CONFIGURATION OF CYLINDRICAL MATERIAL INTO STANDARDIZED BUILDING COMPONENTS AND PRODUCTS DERIVED THEREOF

(71) Applicant: Thomas Andrew Baum, Austin, TX (US)

(72) Inventor: Thomas Andrew Baum, Austin, TX (US)

(21) Appl. No.: 14/848,284

(22) Filed: Sep. 8, 2015

Related U.S. Application Data
(60) Provisional application No. 62/046,401, filed on Sep. 5, 2014.

(51) Int. Cl. B23B 47/28

(52) U.S. Cl. CPC B23B 47/281; B23B 2260/03; B23B 2270/08

(57) ABSTRACT

A rigid, hollow cylindrical jig comprising bolt-actuated centering and clamping mechanisms, a repeating pattern of hole boring guides and end cutting guides enables manual and consistent configuration of cylindrical stock, such as raw bamboo poles, into standard building components able to form unique building constructs and products.

### CROSS REFERENCE TO RELATED APPLICATIONS

The present invention claims priority from U.S. provisional patent application No. 60/704,121, entitled STANDARDIZED RIGID-COUPLING-AGENT AND PERFORATED COLUMN BUILDING SETS AND JIGS FOR CONSISTENT CONSTRUCTION THEREOF, filed on Sep. 5, 2014, the entire contents of which are incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention primarily fills the need for an inexpensive, simple to operate, portable, electricity-independent, tool and methods usable by the lay person for fashioning standardized, inter-connectable building components from readily available natural, relatively straight, cylindrically shaped, easily renewable raw materials found in nature such as bamboo and some tree species from which to assemble building sets and functional products.

Such a tool and methods would be of high value in certain disaster recovery/survival situations, in “green” and/or minimalistic living, small business opportunity and do-it-yourself projects to name just a few. Such a tool and methods would also have value in secondary applications working with other industrially refined cylindrical, or otherwise, material stock.

In the absence of the present invention, the aforementioned is nearly impossible to accomplish without the aid of industrial machinery able to adhere to tight positioning and alignment tolerances, avoid bit slippage difficulties encountered when boring through cylindrical stock walls and able to achieve the long bore stroke distances required.

The present invention pre-supposes and relies upon the use of modern precision engineering and materials in formation of the tool and methods associated with the present invention and on its resulting effectiveness.

More particularly, the present invention is in the technical field of manufacturing tools and methods.

More particularly, the present invention is in the technical field of simple manual tools and methods that enable minimally processed, environmentally-friendly building constructs, building sets and derivative products that can be employed in disaster recovery, construction, business, home and garden, arts, crafts, toys and education with minimal building-set or user specialization. This is contrasted with existing art building sets derived from large, costly, industrial machinery and processes, employing non-environmentally-friendly, non-biodegradable, plastics, composites or metal that require high-precision, high cost and high-skill.

More particularly, the present invention is in the field of tools and methods for consistent manufacturing of standardized, inter-connectable building components.

More particularly, the present invention enables flexible coupling of naturally occurring or manufactured cylindrical stock materials including, but not limited to, bamboo and wood stock.

More particularly, the present invention is in the field of tools and methods that can produce consistent configuration within each piece, from piece to piece, from person to person and from material type to material type.

More particularly, the present invention is in the field of manual, hand-held, portable and electricity-independent tools and methods for consistent production and configuration of inter-connectable cylindrical building components, as well as, building sets and products that inherit such configurations.

More particularly, the present invention is in the field of building sets, building constructs, construction methods and products that are derived from components that have been configured with the tools and methods put forth herein.

### SUMMARY OF THE INVENTION

The present invention specifies multi-functional jigs and methods which when combined with common hand operated drill and saw tools, each either manual or otherwise, enables a lay person to consistently transform a large range of lengths, diameters, types and tolerances of cylindrical stock, including but not limited to raw bamboo and wood stock, into standardized building components containing a repetitive pattern of hole-paths, non-intersecting or otherwise, and end-trimming of components at consistent angle(s).

The present invention enables consistent configuration and thus inter-compatibility of components within each piece, from piece to piece, from person to person and from material type to material type. These building components may, in turn, be coupled using a variety of rigid, semi-rigid or non-rigid auxiliary coupling agents such as elongated pegs of various types, wire and/or twine. Coupling configured components in such a manner can produce a plethora of structures that form the foundation of many derivative products with aesthetic and/or functional value benefitting people and the planet.

Examples of derivative products fashioned by the coupling of bamboo columns that have been configured with the aid of the present invention and possible minor additional customization, include, but are not limited to, a floating raft, a shelter, a ladder, a stretcher, walking stilts, a multi-chamber bird house, a flower planter, a chair, a shelf, a table, an educational construction kit, an art sculpture and a toy, to name just a few.

In essence, the present invention combines rectilinear and polar coordinate systems into one manually operated, electricity-independent device to impart “peg-board-like” patterns of perforation and “miter-box-like” cuts onto a variety of cylindrical source material types and significantly reduce human-error-prone activities in the process.

### BRIEF DESCRIPTION OF THE DRAWINGS

Figure Listing:

FIG. 1: Component and Method Overview of Jig Containing Centered Piece of Hollow Cylindrical Stock Material Being Configured with Auxiliary Hole Boring and Cutting Mechanisms

FIG. 1A: Top and Bottom View

FIG. 1B: Side View

FIG. 1C: Exploded Cross-Sectional View of Hole Path Guide

FIG. 1D: Exploded View of Hole Path Guide

FIG. 2: Important Dimensions of Jig Containing Centered Piece of Hollow Cylindrical Stock Material

FIG. 2A: Top and Bottom View

FIG. 2B: Side View

FIG. 2C: Exploded View of Hole Path Guide

FIG. 3: Example of Several Pieces of Configured Cylindrical Material Coupled with Rigid Elongated Peg Coupling Agents

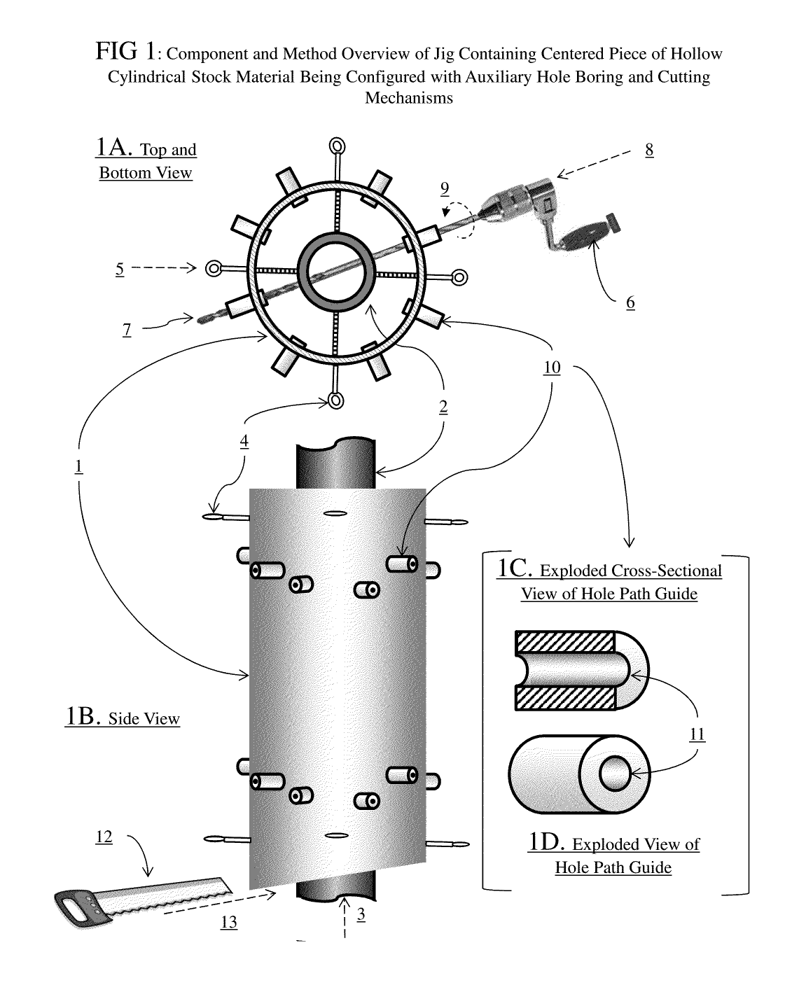

FIG. 1 is an overview of one embodiment of the hollow, cylindrical jig shell (1) of the current invention into which a piece of hollow cylindrical source material (2) has been inserted in an axial direction (3), concentrically centered by eight clamping bolts (4) which have been manually screwed inward (5) toward the center of the jig in order to meet up with the outer walls of the inserted source material to rigidly secure it in place while being acted upon by an auxiliary hole boring tool (6) equipped with an elongated drill bit (7) to which a simultaneous force in the direction of (8) and turning motion (9) is channeled by the jig's “hole-path-guides” (10) and respective holes (11) to, once all hole-path-guides have been drilled into in this manner, impose upon the source material a standard configuration of “hole-paths” exhibiting a specific size, location and angle with respect to each other and to the columnar axis of the source material. The stock may be further acted upon by an auxiliary cutting blade (12) whose cutting angle is guided by the angle of the edge of one end of the “jig shell” (13) so as to cut the stock material at a standard, consistent angle. It is important to note that although the figures reflect a vertically oriented jig, the jig may also be employed in a horizontal orientation.

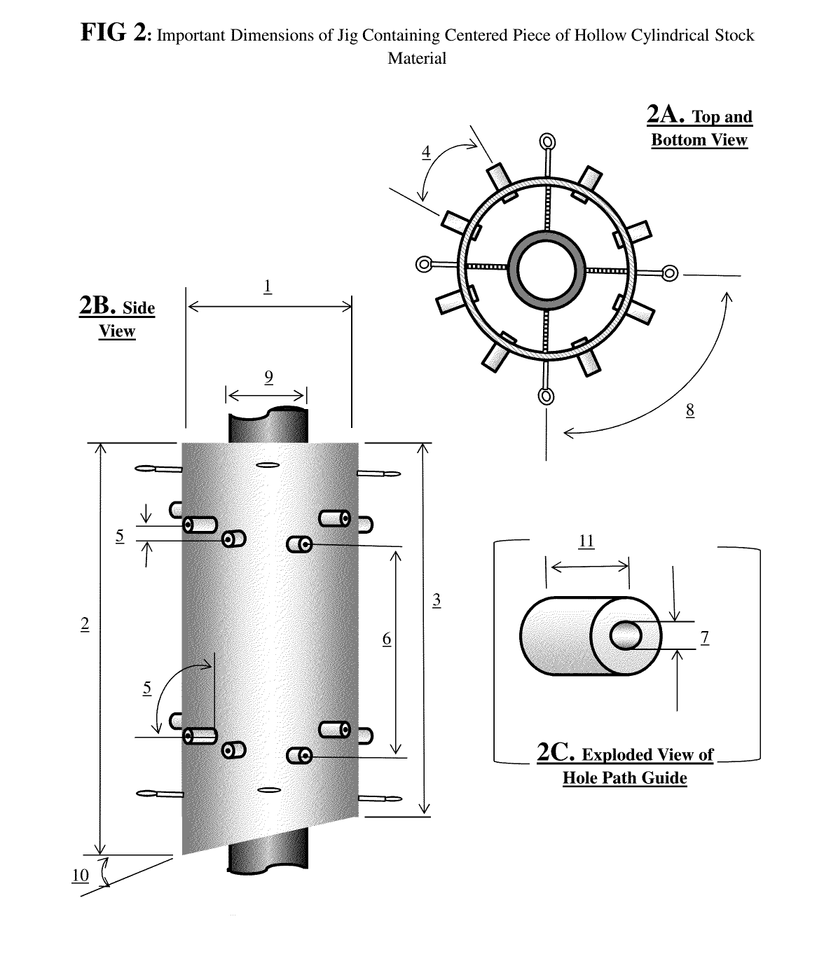

FIG. 2 delineates the important dimensions associated with one embodiment of the current invention including jig shell inner diameter (1); overall jig shell maximum length (2) and minimum length (3); the angles (4) that the axis of each hole-path-guide makes with respect to the axis of its nearest neighbor hole-path-guide when viewed from either end of the jig shell; the angles (5) that the axis of each hole-path-guide makes with respect to the axis of the jig shell; center-to-center distance between adjacent hole-path-guides along the axial direction of the jig shell that lie on the same side of the jig shell and in the same axial plane (6); diameter(s) of the hole-path-guide hole(s) (7) along their full length; the number of, and angle between, adjacent clamping bolts (8) that lie within the same plane perpendicular to the jig shell axis; outer diameter of stock material (9); the angle(s) (10) at each end of the jig shell formed by the slope of the end plane relative to the axis of the jig shell; and, the length of the hole-path-guide (11).

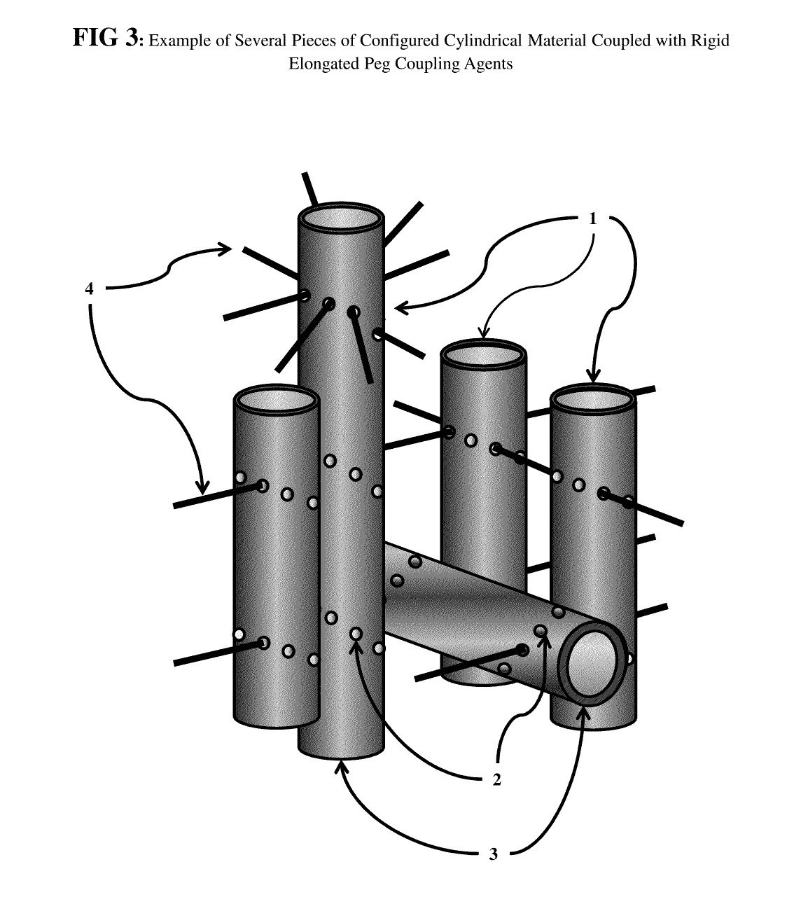

FIG. 3 depicts the general nature of standard inter-coupling compatibility, flexibility and aesthetics associated with components configured via one embodiment of the present invention. It specifically depicts an example of five pieces of hollow cylindrical stock (1) which have been configured in a standard way as evidenced by a repetitive pattern of hole-paths (2) and flatly cut ends (3) which are all coupled together, in one of many possible interconnection configurations, by matching up the equivalently spaced hole-paths and threading rigid-coupling-agents (4) through multiple pieces of configured stock.

### DETAILED DESCRIPTION OF THE INVENTION

Referring now to the invention in more detail, in FIG. 1 through FIG. 3 there are shown the base components of one embodiment of jig, cylindrical stock material, cylindrical stock configuration methods, auxiliary tools used to aid configuration, resulting consistently configured cylindrical components (also referred to as configured columns herein) and rigid coupling agents.

Jig Design—For best stock configuration consistency within each component, from component to component, from person to person and from material type to material type, as configured by the jig of the present invention, the jig design tolerances are envisioned to be as tight as practical and materials as durable as practical.

Multiple embodiments of jig design are possible by varying jig shell material, jig shell shape, jig shell dimensions, jig shell end angles, stock material centering mechanism, stock material clamping mechanism, hole-path-guide quantity, hole-path-guide placement, hole-path-guide size, hole-path-guide shape, hole-path-guide orientation and hole-path-guide material.

Multiple jig methods are also possible by employing different auxiliary hole boring mechanisms as well as material cutting mechanisms. Each of the important jig design considerations are discussed in what follows.

Jig Shell—The jig shell of the present invention provides a rigid structure upon which are mounted, or seamlessly integrated, the hole-path-guides, material stock centering mechanism, material stock clamping mechanism, jig shell ends for guiding saw cuts and comprised of a size, weight and material type that can, generally speaking, accommodate portability, durability and use by a single capable person. The important aspects of the jig shell are set forth below.

Jig Shell Shape—The jig shell shape of the present invention is that of a uniformly hollow cylinder which will suitably accommodate and facilitate symmetrical configuration of stock materials that are also, but not limited to, cylindrically shaped. The jig shell shape with openings at each end accepts stock material of essentially any length assuming stock material is configured in a staged process by either sliding the jig further along the length of the stock or alternatively feeding the stock through the jig for each stage.

Jig Shell Inner Diameter—The inner diameter of the jig shell in the present invention accommodates the largest diameter or width of stock material to be configured with some reasonable degree of clearance to accommodate expected variations in natural, raw stock material width, curvature, bulges, etc. to avoid binding of stock material within jig shell cavity. Design of the jig shell enables it to accommodate a large range of stock material widths.

Jig Shell Length—In addition to accommodating integration of given stock centering and clamping mechanisms, the jig shell length of the present invention accommodates

the specific pattern of hole-path-guides and any repetitions of that pattern along the length of the jig shell, and,

the jig shell end cutting angle(s).

Jig Shell End Angle(s)—In one embodiment of the present invention, the angle of finish or an associated angled attachment, on each end of the jig shell enables it to be employed as a cutting edge guide to cut stock at a specifically designed angle using an auxiliary cutting mechanism such as a hand saw. Other embodiments may provide a jig shell end attachment mechanism that allows setting of a variable cutting angle.

Jig Shell Material—The jig shell material is of sufficient rigidity to accommodate the weight of stock material, clamping of stock material and centering of stock material without deforming the shell to avoid compromising integrity of any stock configurations produced thereof. It also maintains stationary angular orientation and position of the hole-path-guides during hole boring operations. For lasting use in a variety of climates and conditions, the jig shell material is made of rust-resistant and weather-resistant material.

Other Jig Shell Considerations & Embodiments

Jig Shell End Edge Material—This should be made of sufficiently durable material to withstand wear and tear associated with being employed as a cutting guide edge especially if employed for more than occasional use.

Jig Safety & Debris Containment—the jig shell provides a safety barrier that shelters manufacturing operators from material debris during hole boring operations, as well as, a conduit for debris containment and ease of automated or manual removal/cleanup during or once configuration operations are complete.

Hole-path-guides—In the present invention, hole-path-guides are integrated with the walls of the jig shell and serve as channels to guide material boring mechanisms such as, but not limited to, conventional elongated drill bits, ensuring accurate, consistent hole-path position, sizing and orientation to be configured into the stock material.

Number and Placement of Hole-path-guides on Jig Shell—The number of hole-path-guides in the embodiment of the present invention that are depicted in FIGS. 1 and 2 are sixteen, comprised of two sets of four non-intersecting hole-path-guide pairs, where each pair consists of two mutually and angularly aligned hole-path-guides, located on opposite sides of the jig shell. Notwithstanding, this number of hole-path-guides and whether they are intersecting can vary depending on the design of a specific jig and its intended configuration pattern.

Building Construct Design—For the embodiment depicted in FIGS. 1 through 3, the building construct includes coupling of components by aligning one or two hole-paths and inserting a rigid-coupling-agent of properly sized width and length completely through each aligned hole-path. Rotational rigidity between coupled components is achieved in cases where more than one coupling agent is employed at separate hole-path locations along the length of components being coupled. The building construct also includes adding additional rigid-coupling-agents through single hole-paths for added function or visual aesthetics.

Stock Material Strength—For a given application and stock material, hole-path configurations are kept to a minimum in order to minimize material removal so as to maintain strength of the resulting building components. Specifically, too many holes, too closely spaced can result in weakening of stock material so as to make it incompatible with the intended application.

Compatibility With Existing Building Standards—In the present invention, placement and number of hole-path-guides can be tailored to achieve hole-path patterns that are compatible with existing building material standards. For example, vertical center to center spacing of hole-paths might align with holes in standard, flat peg-board material.

Scaling of Building Components—In the present invention, hole-path-guides can be strategically sized and positioned on a given jig to facilitate at least partial coupling between building components that are scaled up or down relative to it. For example, vertical center to center separation between hole-paths and between hole-path diameters can be set at multiples of 2× and 0.5× of each other when scaling up or down, respectively. Full coupling between components of different scales can be achieved via “coupling adapters”.

Placement of Hole-path-guides Relative to Each Other—In the present invention placement of hole-path-guides relative to each other includes, but is not limited to, ensuring the resulting hole-paths in stock material are non-intersecting and that the hole-path angles relative to each other offer meaningful building construct coupling and/or aesthetic value. For example, the embodiment depicted in FIGS. 1 through 3 enables coupling at angular intervals of 45 degrees around the circumference of each building component.

Angle of Hole-path-guides Relative to Jig Shell Axis—As envisioned in the present invention, the angle between the axis of the hole-path-guide and that of the jig shell axis is intended to be highly precise to maintain consistency of configuration from hole to hole and may be oblique to accommodate standard building constructs that require or allow oblique coupling or aesthetics.

Inner Diameter of Hole-path-guide—The inner diameter of the hole-path-guide of the present invention is intended to be precisely sized for a given design construct and as such the boring mechanism and coupling agent(s) should be well matched to its size but still allow for easy, unbinding insertion and removal.

Hole-path-guide Length—Length of the hole-path-guide of the present invention is designed to maximize practical and necessary alignment of boring mechanism and hence the resulting hole-paths.

Hole-path-guide Material—Materials used for hole-path-guides of the present invention are designed for durability in order to maintain lasting integrity and consistency of configuration of the components the present invention aids in producing. Two important material features of the hole-path-guides are

Casing—the outer casing of the hole-path-guide is made of rigid material that is integrated with, or securely fastened to, the jig shell so as to eliminate the potential for movement causing variation in alignment during the hole boring process.

Inner Wall Lining—the inner wall lining is made of highly durable material relative to the boring mechanism so as to minimize wear and loss of configuration precision over extended use.

Stock Centering Mechanism—The stock centering mechanism, as envisioned in the present invention, optimizes centering of stock material while minimizing introduction of human error. The centering bolts shown in the embodiment of FIGS. 1 and 2 have demarcations along the bolt stem (not visible in the FIGs) as a visual aid in centering the stock material between opposing bolt tips. The minimum number of bolts required for practical centering at each end of the jig shell is three, while four are depicted in the embodiment show in FIGS. 1 and 2. Although the precise positioning of centering bolts along the length of the jig is not critical, their angle of entry is and are thus manufactured to ensure bolt tips meet at the center of the jig when fully screwed in. The centering mechanism is designed to accommodate centering of stock within the full range of material size accommodated by the jig shell. That is, from essentially zero diameter to slightly less than the diameter of the jig shell itself.

Stock Clamping Mechanism—The stock clamping and release mechanism in the present invention is envisioned as one achieved via simple manual manipulation while not impacting the integrity of the stock material. FIGS. 1 and 2 depict one embodiment of such a clamping mechanism via the two sets of four bolts that serve to clamp, and as previously described to center, the stock near each end of the jig shell. Exact location of clamping bolts along the length of the jig shell is not critical as long as stock material is securely held during processing. The clamping mechanism is designed to accommodate clamping of stock within the full range of material size accommodated by the jig shell. That is, from essentially zero diameter to slightly less than the diameter of the jig shell itself.

Other Envisioned Jig Mechanisms—The present invention delineated herein is envisioned as providing additional functions that may be useful for a given application or material type. Such functions include, but are not limited to, boring axial holes into the end(s) and possibly completely through the stock material, heat treating of stock material, filing of stock material, sanding of stock material, painting of stock material, branding of stock material, engraving of stock material, and manufacturing and/or fashioning compatible rigid-coupling-agents, to name a few.

Jig Use Methods

Jig Size Selection—Theoretically, the present invention can be produced to accommodate all possible material stock diameter sizes by ensuring the jig shell is larger than the largest expected stock diameter. However, for practical purposes, the present invention can be built to accommodate the range of stock material size for a given application. Selecting a jig size whose diameter is close to, yet always larger than, the expected stock size will improve efficiency and accuracy of the resulting component configuration.

Feeding, Centering and Clamping Stock Material—FIG. 1 depicts one embodiment of the present invention into which a piece of hollow cylindrical source material (2) is fed in the axial direction (3). Once stock is fed to at least the full length of the jig, it is concentrically centered at each end by four clamping bolts (4), respectively. To do so, these are manually screwed in an inward direction (5) toward the center of the jig until meeting up with the outer walls of the inserted source material and rigidly securing it in its visually centered location at each end of the jig.

Hole-path Configuration—Hole-paths are then configured in stock material by employing an auxiliary hole boring tool such as, but not limited to, a hand drill (6) equipped with an elongated drill bit (7) whose diameter is precisely sized for insertion into the jig's hole-path-guides. To do so, one inserts the drill's bit tip into one of the hole-path-guides which channels the bit in the desired direction and location until it meets the outer surface of the stock material. Applying a simultaneous force to the hand drill in the direction of (8) and a turning motion (9), the bit channeled by the jig's hole-path-guide (10) will bore a hole-path completely through one or both sides of the hollow stock material. This process is repeated for each of the remaining hole-path-guides on the jig or until all hole-paths are bored for this first segment of the stock material.

Release, Feed and Re-Align Stock—At this point in the process, the clamping/centering mechanism(s) are released, the stock material is fed further through the jig making sure not to rotate the stock material relative to the jig. The stock material is fed up to the point at which the last set of bored hole-paths aligns with the last set of hole-path-guides before exiting the jig. Regarding the embodiment shown in FIG. 1, the stock is fed by only a single register of repeated hole-path-guides, that is, the distance indicated by “6” in FIG. 2. Note: In all embodiments, the jig accommodates “X” number of repeated sets of hole-path-guides along its length and thus the stock would be fed past X−1 registers of hole-path-guides between each clamp/bore/release/re-clamp cycle. At this point, rigid-coupling-agents should be inserted through the last set of aligned hole-path-guides and bored holes in order to maintain integrity of alignment for the next set of holes to be bored.

Repeat Until All Holes Configured—Repeat steps (b) through (d) until the desired length of stock has been configured with hole-paths.

Cut Stock to Size and Desired End Angles—At the desired stage and at the desired angle, the multi-function jig can be used as a cylindrical “miter box” by centering, clamping and cutting the stock at specific angle(s) of taper at each end of the jig.

Employ additional supported functions of the multi-function jig as needed.

Component Coupling Methods

Given a set of cylindrical components that have been consistently configured via the jig and methods outlined above, they may be coupled and secured using auxiliary coupling agents and securing methods to form structures and function as follows:

Rigid-coupling-agents—Rigid-coupling-agents comprised of relatively inflexible material such as, but not limited to, metal re-bar, bamboo skewers, wooden dowels, tooth pics, plastic or composite dowels or metal bolt material may be threaded through hole-paths coupling two or more components together as shown in FIG. 3.

Rigid-coupling-agent Securing Method(s)—method(s) in which rigid-coupling-agents may be secured in place. Depending on the embodiment and application, these are one or more mechanisms or methods that prevent coupling agents from slipping out of their desired stationary positions once threaded into their hole-path(s) formed by one or more adjacent column(s). Such methods may include, but are not limited to

Nut and Bolt Method—in which a nuts of appropriate size and thread are screwed onto each end of elongated rigid bolt coupling agents until tightened against walls of coupled components.

Twine-based Securing Method—in which twine, wire or similar material is tied and/or wrapped around one or more coupling agent protrusions. This may include tying and/or wrapping both coupling agent and column together.

Grommet-based Securing Method—circular grommets, washers, push-on nuts, washers, rubber bands or similar may be slipped snuggly onto the coupling agents until contacting outer edge of column.

Adhesive-based Securing Method—adhesive, glue, tape or similar methods may be used to steadfastly and semi-permanently a-fix the location of rigid-coupling-agent(s) by applying adhesive to areas of elongated agent(s) that are in contact with the column(s) into which it/they are threaded.

Semi-Rigid-coupling-agents—coupling agents comprised of semi-rigid materials sized for threading through hole-paths and coupling one or more adjacent configured columns. Semi-rigid materials include, but are not limited to, wire, pipe cleaners and flexible plastic rods.

Securing Semi-Rigid-coupling-agents—is often possible by simply bending, wrapping and/or tying the coupling agent in ways that secure adjacent components together. Flexible rods can be secured via aforementioned methods for rigid coupling agents.

Non-Rigid-coupling-agents—are highly flexible agents that include, but are not limited to, twine, string, rope/elastic and thread. These often require use of an insertion mechanism such as a needle for threading through the hole-paths.

Securing Non-Rigid-coupling-agents—after threading these agents through hole-paths, securing them may be accomplished simply by tying the agents in knots or around auxiliary material large enough to prevent unthreading back through hole-paths or by tying the agents directly to the components being coupled.

Resulting Design Constructs

It is recognized that the present jig and methods invention enables a plurality of design constructs each of which is tied to a given jig design and the resulting stock material configuration. Key design construct considerations are as follows:

Simple building set embodiment containing single column threaded with one or more rigid-coupling-agents—Minimally speaking, a single cylindrical component may be threaded with one or multiple rigid-coupling-agents to create a plurality of utilitarian and/or aesthetic embodiments depending on the configuration of hole-paths and any specially added application configurations of the cylindrical component.

Coupling two or more consistently configured columns within the same two-dimensional plane via rigid-coupling-agents—more interesting and germane building construct embodiments associated with the present invention materialize for building sets that contain two or more columns whose hole-paths are configured in a consistent standard manner. More specifically, two or more columns each containing two or more hole-paths spaced equal distances apart along the length of each column can be placed on a flat plane, aligned to each other and threaded (in this case coupled) with two or more rigid-coupling-agents of sufficient length to thread entirely through all aligned columns and associated hole-paths. In this manner, the rigid-coupling-agents serve as a coupling mechanism among the adjacent columns. At each coupling or joint location, the rigid-coupling-agents simulate dowels connecting two adjacent bodies. However, rigid-coupling-agents have the added advantage of distributing the shear forces at each joint across the full length of the agent and thus can theoretically accommodate greater forces than a traditional dowel coupling mechanism. Furthermore, the rigid-coupling-agents can add utilitarian and aesthetic value assuming the ends intentionally protrude beyond or between the walls of the adjoined columns.

Coupling three or more consistently configured columns along multiple angular planes via rigid-coupling-agents—Scaling the aforementioned coupling mechanism to multiple angular planes simply requires that the columns be consistently configured with hole-paths that are again equidistant along the length of each column but also that there are equidistant hole-paths that lie on different angular planes and are shifted along the length of the columns by a distance at least equal to the width of the rigid-coupling-agents in order to avoid overlap of hole-paths and thus collision of threaded agents. For example, second and third angular planes formed by additional hole-paths might lie at 45 degrees and 90 degrees, respectively, and be shifted one and two agent widths higher or lower, respectively, relative to the first. In this case, looking down the vertical length of a circular, hollow column threaded with an agent occupying each angular plane will appear as a pie chart divided into eight equal slices and exhibit eight rigid-coupling-agent protrusions that could theoretically accommodate the coupling of additional columns (or otherwise). Taking this concept to the limit means that this building construct embodiment is extendable in three-dimensional space given a consistent configuration.

Adapting (coupling) two or more building constructs each having different self-consistent configurations—Building constructs containing columns with dissimilar, yet self-consistent configurations may be coupled using adaptor components that share the configuration features of each building set.

In summary, the said building construct enables coupling of column-to-agent, column-to-agent-to-column and building-set-to-building-set in a multitude of combinations. Thus, building constructs containing consistently configured column, rigid-coupling-agent and adaptor components as described above facilitate construction of a plurality of derivative utility and maintains a unique “design signature” that is inherited and reflective of the building construct employed as discussed further below.

Configuration Inheritance by Derivative Components and Products

Much the same as popular standard building sets are patent protected by a specific coupling design signature, it is recognized that building components configured with the present invention, and derivative products made thereof, will inherit the unique configuration, utility and design signature of a given jig embodiment and thus are considered protected within the realm of the present invention.

Furthermore, it is recognized that the present invention will enable a plurality of building constructs.

Furthermore, it is recognized that the present invention will enable configuration of cylindrical components with at least one specially placed hole-path.

Furthermore, each hole-path may be bored either transversely, as shown in the set of figures, longitudinally or obliquely, each completely through the entire width or length of a given column. Furthermore, each end of a component coupling agent may protrude significantly beyond opposite outer walls of one or more coupled columns.

Furthermore, each significantly protruding end of a given coupling agent may serve aesthetic and/or functional purposes. One such purpose may be for a protruding end of one or more threaded coupling agent(s) to mate up with and thread through a second similarly configured cylindrical component, accessory or adapter thus facilitating interconnection or coupling of one or more additional component(s) or component set(s).

Furthermore, this coupling mechanism is forgiving for columns and attachable components that are similarly configured but whose tolerances are relatively imprecise.

Furthermore, if multiple threaded coupling agents mate with similarly configured and aligned hole-paths in one or more additional columns, they serve to provide a degree of rotational stability and additional weight bearing strength to the coupling formed thereof between said columns.

Furthermore, both rotational stability and weight bearing strength increase to a maximum at the point of closest possible coupling distance between adjacent columns. That said, greater coupling distances accommodate or enable somewhat misaligned hole-paths to still be coupled by rigid-coupling-agents.

Furthermore, rigid-coupling-agents threaded completely through hole-paths such that each end protrudes significantly beyond the outer walls of a given column achieve a unique aesthetic design signature.

Further still, the protruding rigid-coupling-agents may serve additional utilitarian or adornment purpose(s) thereof.

Furthermore, the recognition that the present invention enables creation of building kits for easy, flexible, modular construction of a plurality of utilitarian and aesthetic structures and simple modification, deconstruction and reconstruction thereof.

Furthermore, the recognition that when implemented properly, the novel component configuration and coupling methods enabled by the present invention are flexible and forgiving enough to accommodate sizing variations in naturally occurring source material such as that found in bamboo.

Furthermore, the recognition that structures formed with such building constructs when its component parts are derived from chemically untreated material such as natural bamboo will have little to no negative impact on wildlife and the balance of nature.

The recognition that such building constructs may be scalable in at least three significant ways. Firstly, structures can be scaled from small to large by coupling many small building set components to form a large integrated structure. Secondly, that large structures can be assembled from building sets comprised of components whose individual sizes have been scaled up. And thirdly, larger structures can be produced from a combination of small scale and larger scale components that are coupled using the same building paradigm. Practically speaking then, this building paradigm can produce structures whose sizes range from hand-held to that of large buildings.

Recognition that a configured column and rigid-coupling-agent in its simplest embodiment is self-supporting in that it does not necessarily require additional coupling agent securing agents or fasteners to maintain a coupled state between multiple coupled components for some applications.

Recognition that coupling of structures made from two building sets whose component sizes and/or configurations are consistent within a given set but not between sets, may be achieved via an “adapter” component that serves to adapt one building set size to the second by employing the same general coupling paradigm but with a unique configuration that facilitates the coupling required. This can facilitate evolution and backward compatibility of design generations of a given building set or derivative kit.

In a general embodiment of the present invention, a building set derived from a jig represents a creative outlet for constructing anything the imagination may envision within the confines of the number and size of components included but also with the ability to expand it without limit by acquiring additional components, customizing individual components and/or augmenting them as desired.

In another more specific embodiment of the present invention, a building set represents a toy building kit for constructing and deconstructing a plurality of structures with functional utility and unique design.

In another embodiment of the present invention, a building set represents a kit for constructing pollinator attractor, husbandry and research stations including, but not limited to those for bees, moths, hummingbirds, bats, flies, butterflies.

In another embodiment of the present invention, a building set represents a kit for constructing bird attractor, husbandry and research habitats.

In a further embodiment of the present invention, a building set represents a kit for constructing spider attractor, husbandry and research habitats.

In another embodiment of the present invention, a building set represents a kit for constructing flower rearing and display structures.

In another embodiment of the present invention, a building set represents a kit for constructing a combination habitat that may include, but is not limited to, one or more of the aforementioned embodiments.

What is claimed is:

1. A multi-function tool and methods for standard configuration of cylindrically shaped stock material of effectively any length, any diameter and of a relatively wide degree of self-contained variability as characteristic of raw bamboo, into compatible building components, comprising:
a material configuration jig further comprising:
a rigid and cylindrically shaped jig shell for accepting stock material to be configured;
a stock material centering mechanism for accurately centering stock material within the jig shell;
a stock material clamping mechanism for securely clamping stock material within the jig shell;
a pattern of specifically sized, placed and angled hole-path-guides rigidly integrated with and penetrating the perimeter walls of the jig shell so as to accept and channel an auxiliary material boring mechanism onto clamped and centered stock material; and,
two jig shell ends to guide an auxiliary material cutting mechanism for cutting stock material at a desired angle; and
methods for configuring stock material via the jig and auxiliary mechanisms.

2. The jig and methods of claim 1, wherein it may accept a large variety of stock cylindrical material types including, but not limited to, bamboo, wood, plastic, metal and composites.

3. The jig and methods of claim 1, wherein humanly impossible cylindrical material configurations become possible via its inherent design that minimizes human error associated with consistent alignment and boring of holes into cylindrical stock.

4. The jig and methods of claim 1, wherein the stock material may be configured by a single person using manual means for a low cost without the need for industrial equipment or electric power while also supporting the use of electrically powered tools if available.

5. The jig and methods of claim 1, wherein they enable consistent stock material configuration within a component, from component to component, from person to person and from material type to material type thus enabling efficiencies derived from standardized building components.

6. The jig and methods of claim 1, wherein the jig design may be scaled up or down in size to accommodate larger or smaller stock material sizes for improved handling, configuration-accuracy and configuration-efficiency.

7. The jig and methods of claim 1, wherein they provide a foundation for adding more material configuration capabilities including, but not limited to, boring axial holes into the end(s) of stock material, heat treating of stock material, filing of stock material, sanding of stock material, painting of stock material, branding of stock material, engraving of stock material, and manufacturing and/or fashioning rigid component coupling agents.

8. The jig and methods of claim 1, wherein they have been designed to be portable by a single capable human for use in the field as needed.

9. The jig and methods of claim 1, wherein the resulting configured components may be coupled via a wide variety of coupling agents appropriate for a specific application including, but not limited to, re-bar, bamboo poles, bamboo skewers, elongated wooden dowels, pipe, elongated bolt stock, tooth picks, wire, plastic rods, pipe cleaners, string, rope, etc.

10. The jig and methods of claim 1 resulting in standard building components and the coupling agents of claim 9, may combine to form unique building constructs that inherit the unique design and utility signature imposed by the jig and coupling agents.

11. The unique building constructs of claim 10, wherein unique building sets may be derived and, in turn, also inherit aspects of the unique design and utility signature.

12. The unique building sets of claim 11, wherein unique products may be derived and, in turn, also inherit aspects of the unique design and utility signature.

13. The jig and methods of claim 1 and coupling agents in claim 9, wherein the jig design may incorporate different placements, angular orientations, hole sizes and one or multiple repeating patterns of hole-path-guides so as to enable different hole-path configurations to be imposed on stock material, and wherein when combined with specific coupling agent(s) may result many unique building constructs that inherit the utility and design signature of the specific jig, methods and coupling agents incorporated.

14. The building sets of claim 11, wherein it is possible to create adapters that enable inter-coupling of building set components derived from different jig designs.

15. The products in claim 12, may include, but are not limited to, a floating raft, a shelter, a ladder, a stretcher, walking stilts, a multi-chamber bird house, a planter, a chair, a shelf, a table, an educational construction kit, an art sculpture and a toy.

16. The jigs and methods in claim 1, wherein they provide economic and/or survival opportunities for individuals where access to plentiful supplies of configurable stock material may be harvested, distributed and/or transformed into standard building components and/or derivative building sets, products and/or services.
